(19) United States
(12) Patent Application Publication
(10) Pub. No.: US 2002/0005899 A1
(43) Pub. Date: Jan. 17, 2002

(54) IDENTIFICATION TRANSACTION RECORDING SYSTEM

(76) Inventors: JOHN B. FEKAS, LAWRENCE, KS (US); JONATHAN R. DAVIS, LAWRENCE, KS (US)

Correspondence Address: KENT R. ERICKSON, ESQ, SHUGHART THOMSON & KILROY, P.C., TWELVE WYANDOTTE PLAZA, 120 WEST 12TH STREET, KANSAS CITY, MO, 64105, US

(21) Appl. No.: 09/198,750

(22) Filed: Nov. 24, 1998

(51) Int. Cl. H04N 7/18

(52) U.S. Cl. 348/156

(57) ABSTRACT

An identification transaction recording system includes a system enclosure having a document frame to receive an identification card and a document video camera to capture images of the identification card, a portrait video camera to capture images of the face of a person proving their identity, a profile video camera to capture images of the person placing their identification card into the document frame and a side view of the person's face, and a video cassette recorder to record images captured by the video cameras. Video combining circuitry is used to generate a composite image of the component images captured by the video cameras for recording on the recording device.

Background of the Invention The present invention relates to entry control systems and, more particularly, to a system for recording the act of presenting identification credentials.

It is often desirable to control the entry of individuals into various premises. This is often done for reasons of security. For example, military installations often restrict entry to persons with orders to be on the particular base. In other cases, entry is restricted to dues paying members and their guests, such as private clubs. In the case of establishments serving alcoholic beverages or featuring gambling or other adult entertainment, laws require proprietors of such establishments to restrict entry by age, usually twenty-one years old or another prescribed age. This is usually accomplished by “carding”, that is, by requiring an individual to produce a legal identification card which shows proof of the required age.

Regardless of the prevailing laws, some underage individuals will attempt to gain entry to such places, using counterfeit, falsified, borrowed, and, in some cases, stolen identification cards. The current state of the art of graphics technologies commonly available makes such counterfeiting of identification cards easier than in the past. In order to enforce laws against underage drinking, districts often send undercover police officers or liquor control agents into establishments, such as night clubs, bars, and the like, to spot check for underage persons present. Because possession of a counterfeit driver's license or liquor control identification card is usually unlawful, an underage youth who gained entry by such means will often discard or hide the fake identification card. If caught by authorities, an underage patron will often simply claim that he or she was not carded.

While gaining entry to an adult establishment may be regarded as harmless entertainment by some youths, the consequences for the owner are often more serious and may involve fines and even closure of the establishment for a time and, thus, loss of income. What is needed is a system for conclusively demonstrating that a proprietor has made a good faith effort to comply with laws restricting entry into their establishments to persons of a required age.

### SUMMARY OF THE INVENTION

The present invention provides a system for recording, not only an identification card presented, but also the act of presenting the identification. The system includes an identification system enclosure with a document frame to receive an identification card or document. Located within the enclosure is a document video camera focused on the document frame along with one or more lamps to illuminate the identification card. The enclosure is positioned near the door of a premises for which entry is to be controlled. A portrait video camera is positioned and focused to scan the face of the person wishing to gain entry. A profile video camera is positioned and focused to scan a side view or profile of the patron and, additionally, the placement of the identification card into the document frame. Finally, an entry line video camera is positioned outside the door of the establishment to scan images of those waiting in line at the door.

The four cameras are connected through image combining circuitry, such as a quad split unit, to an image recording device, such as a video cassette recorder (VCR). A quad split unit is a conventional video effects device which combines images from a maximum of four video sources as reduced sized image components of a composite video image. Quad split units are often used in security systems to enable a guard to monitor four security cameras simultaneously. Such devices usually allow an operator to isolate on a selected one of the image components in a full screen size for a more detailed view. The output image of the quad split unit is recorded on the VCR, preferably along with the current time of day and date, and displayed on a video monitor.

In operation of the present invention, an operator directs the person seeking entry to place their identification card into the document frame and to stand at a location marked on the floor, facing the portrait camera. The profile camera scans placement of the identification card into the document frame and a side view of the patron. The portrait camera scans the face of the patron, while the document camera scans an image of the identification card. The operator operates a switch located on the system enclosure to cause the quad split unit to isolate on the identification card in a full screen size image. If the identification card appears genuine and the information observed on the card indicates that the patron is of the legally required age, the operator directs the patron to retrieve their identification card from the document frame and allows entry into the establishment. This may involve releasing a solenoid locked door. On the other hand, if the operator suspects that the identification card is forged or counterfeit, the operator denies entry and orders the patron to leave.

Images of the entire identification transaction, as scanned by the document, portrait, and profile cameras and, additionally, the current situation outside the door, as scanned by the entry line camera, are recorded on a cassette in the VCR, along with the time and date. If it is later determined that an underage patron gained entry and now claims that he or she was not carded, the cassette can be replayed for authorities.

Use of the identification transaction recording system of the present invention provides proof that the proprietor of an establishment has made a good faith effort to restrict entry to persons of legal age. Additionally, the presence of the system and the knowledge that such a system is in use at an establishment will likely discourage underage persons from attempting to unlawfully gain entry into such an establishment.

### OBJECTS AND ADVANTAGES OF THE INVENTION

The principal objects of the present invention are: to provide an improved entry control system; to provide an identification transaction recording system for recording the acts of persons presenting identification credentials to gain entry into a premises; to provide such a system including a system enclosure with a document frame to hold an identification card or document, lamps to illuminate the card, a document video camera aimed and focused on the document frame and video cameras to scan the face of the person seeking entry and to scan a moving image of the person placing an identification card in the document frame; to provide such a system which includes a conventional quad split unit which combines reduced size images from the video cameras into a composite image with the component images from the cameras positioned in respective quadrants of the composite image, the composite image being recorded on a video cassette recorder (VCR) and displayed on a video monitor; to provide such a system including selection switches mounted on the system enclosure and connected to the quad split circuitry to allow a selected component image, preferably the document image, to be recorded and displayed at a full screen size; to provide such a system including an entry line video camera positioned and aimed to scan images of persons waiting in line to enter the establishment, the entry line camera being connected through the quad split unit to the VCR and the video monitor; to provide such a system which greatly enhances the ability of a proprietor to demonstrate that a good faith effort has been made to meet the legally required duty to prevent underage persons from entering their establishment; and to provide such an identification transaction recording system which is economical to manufacture, which is effective and efficient in use, and which is particularly well adapted for its intended purpose.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a simplified block diagram illustrating the principal components of the identification transaction recording system which embodies the present invention.

FIG. 2 is a side elevational view of a system enclosure of the system with an illumination lamp shown in phantom lines and with a portion of a side wall broken away to illustrate a document video camera within the enclosure.

FIG. 3 is a top plan view of the system enclosure of the present invention shown in FIG. 2 and further illustrates a control logic circuit board in phantom lines.

FIG. 4 is a diagrammatic plan view of an entry control station in which components of the identification transaction recording system of the present invention are installed.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to the drawings in more detail:

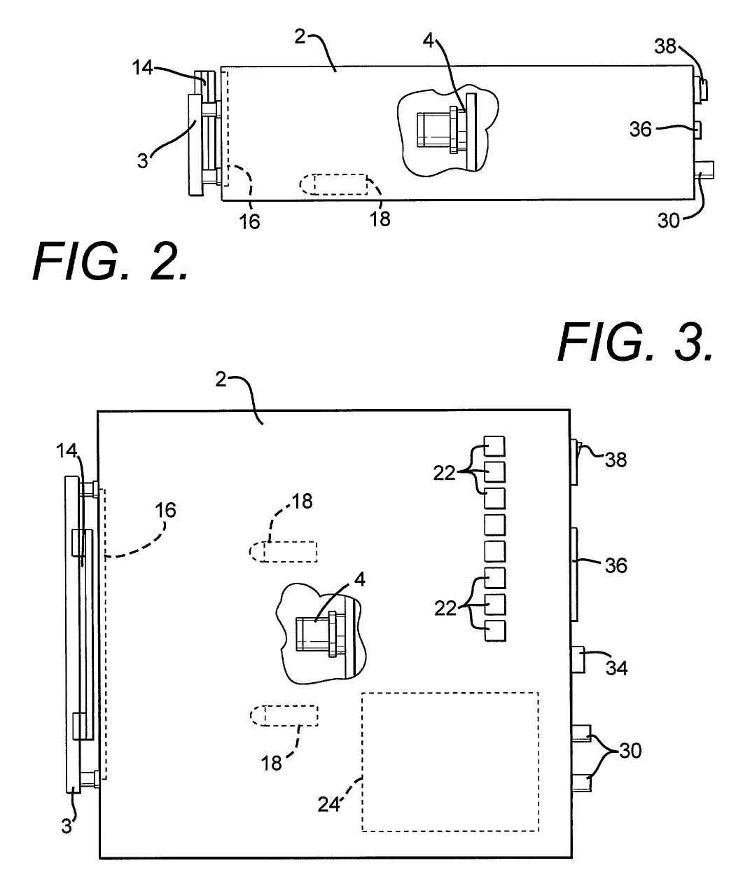

The reference numeral 1 generally designates an identification transaction recording system which embodies the present invention. The system 1 generally includes a system enclosure 2 having a document frame or jig 3 (FIGS. 2 and 3) mounted thereon and a document video camera 4 mounted therein, a portrait video camera 5, a profile video camera 6, a quad split unit 7, a video cassette recorder 8, and a video monitor 9. The system 1 records images of the act of placing an identification card 10 into the document frame 3 by an individual 11 seeking entry into a premises 12 and, additionally, records images of the card 10 and the face of the individual 11.

Referring to FIGS. 2 and 3, the system enclosure 2 may be any convenient form of enclosure to house selected components of the system 1. The illustrated enclosure 2 has the document frame 3 mounted on a front end thereof. The document frame 3 includes walls forming an identification document or card receiving slot 14. The slot 14 is positioned in front of a transparent window plate 16, such as a pane of glass or clear acrylic resin, in alignment with the document camera 4. The enclosure 2 includes lamps 18 aimed toward the document frame 3 to illuminate a card 10 therein for scanning by the document camera 4.

The document camera 4 is a conventional video camera and includes optical elements (not detailed) which are adjusted to focus on and tightly frame the document frame 3 to obtain a clear and adequately contrasted image of the card 10 positioned within the document frame 3. The document camera 4, and other video components within the system 1, adhere to a conventional video format, such as NTSC or other analog or digital video industry standard, with regard to scan line number, synchronization, reference levels, and the like.

The illustrated video combining circuitry is a quad split unit 7 which is a conventional video effects circuit which accepts video signal inputs from a maximum of four video sources at one time and generates a composite video image having reduced size quadrant images provided by the input sources. The circuitry of the quad split unit 7 may be mounted in the system enclosure 2 or may be mounted in its own housing (not shown) and positioned separate from the system enclosure 2. The quad split unit 7 has circuit provisions for converting any of the component images to a full frame image, thus occupying the entire output image, for a more detailed view of the selected image.

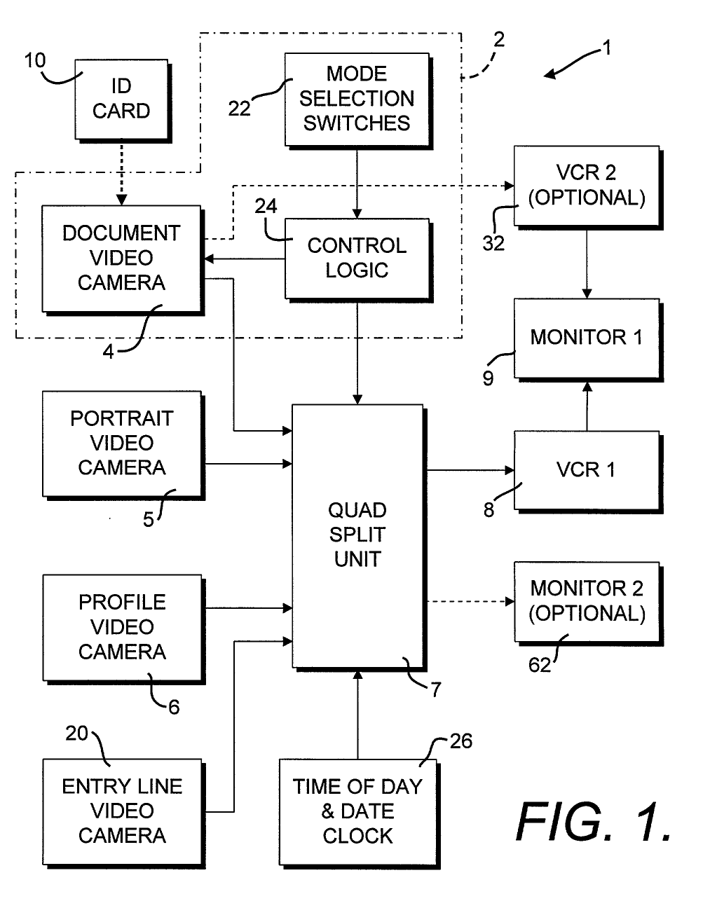

Referring to FIG. 1, the document camera 4, the portrait camera 5, and the profile camera 6 are all coupled or connected to inputs of the quad split unit 7, as by conventional cables. A fourth video camera, designated as entry line video camera 20, is also connected to the quad split unit 7. An array of mode selection switches 22 are mounted on the system enclosure 2 and are connected through control logic circuitry 24 to a control input of the quad split unit 7. The mode switches 22 select the composite image mode in which images from all four cameras are present in a composite image or allow isolation on the image from any one of the four cameras 4, 5, 6, or 20. The image from the document camera 4 is of particular interest for isolation since this provides greater legibility of the information on an identification card 10 positioned in the document frame 3. The system 1 preferably includes time of day and date circuitry 26 which is connected to the quad split unit 7 and which causes time of day and date indicia (not shown) to appear in the composite image output from the unit 7. Additional functions may be assigned to the remaining mode switches illustrated, for example, such as pause/continue functions of the VCR 8.

The system enclosure 2 has a pair of conventional video connectors 30, one of which provides for connection to the quad split unit 7 and the other which allows connection to an optional second video cassette recorder (VCR) 32. The VCR 32 may be used to record only images of the identification cards 10 placed in the document frame 3 in a full frame format. A power supply connector 34 on the system enclosure 2 receives power from a power supply (not shown), such as a 12 volt DC power supply, to operate circuitry within the enclosure 2. The enclosure 2 has a control connector 36, such as a DB-25 connector, which carries control logic signals from the control logic circuitry 24 to the quad split unit 7 to control its functions. An on/off power switch 38 completes the functions of the back panel of the system enclosure 2.

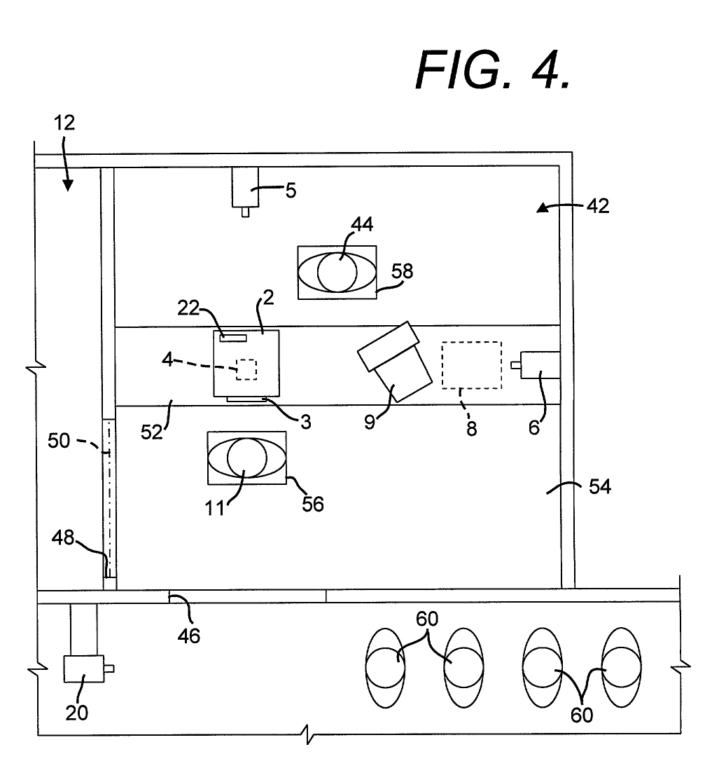

FIG. 4 illustrates an exemplary installation of the system 1 in an identification station 42 of a premises 12, such as a night club, bar, or other establishment. The station 42 is staffed by an operator 44, who may be a security guard, a cashier, or the like. The station 42 is positioned between an outer doorway 46, or initial entry way, and an inner doorway 48 which opens into the premises 12. The inner doorway 48 may include a door 50, such as a solenoid locked door, which is released by the operator 44 when the person 11 seeking entry has presented satisfactory identification. The identification station 42 may include a counter 52 on which the system enclosure 2 is positioned.

In the illustrated identification station 42, the system enclosure 2 is positioned on the counter 52, along with the video monitor 9, and the VCR 8 is positioned beneath the counter 52, as on a shelf. The floor 54 of the identification station 42 has a patron index rectangle 56, or other location marks, applied thereto to inform the patron 11 where to stand for the identification transaction. The portrait video camera 5 is mounted in alignment with the index 56 to scan an image of the face of the patron 11. The profile camera 6 is mounted to the side of the index 56 to capture images of the patron 11 placing an identification card 10 into the document frame 3 and also to capture a side view of the face of the patron 11. An operator index rectangle 58 may also be applied to the floor 54 to locate the operator 44 and avoid blocking the portrait shot from the portrait camera 5 by the operator 44. The field of view of the profile camera 6 is preferably wide enough to capture an image of both the patron 11 and the operator 44, with the system enclosure 2 positioned therebetween. The entry line camera 20 is mounted outside the outer door 46, and captures images of potential patrons 60 waiting in line to enter the premises 12. Although not shown or detailed, the system 1 may include microphones and circuitry for recording the sounds of conversation between the operator 44 and the patron 11, in addition to the video components detailed.

In operation of the identification transaction recording system 1 of the present invention, the operator 44 powers up the system 1 and directs the first patron 11 to enter to place his or her identification card 10 into the document frame 3 and to stand within the patron index rectangle 56. The portrait camera 5 and profile camera 6 capture moving images of the patron 11 placing an identification card 10 into the document frame 3, while simultaneously, the document camera 4 captures moving images of the card 10 entering the document frame 3. The operator 44 operates one of the mode switches 22 to cause the image of the card 10 to be isolated on at a full frame size which allows the operator 44 to inspect the image of the card 10 displayed on the monitor 9. If the age of the patron 11 as indicated by the card 10 is sufficient, the operator 44 directs the patron 11 to remove the identification card 10 from the document frame 2 and allows the patron 11 to pass through the inner doorway 48 into the premises 12. The doorway 48 may be controlled by a releasable door 50 or by a second employ or security guard. If the age indicated by the card 10 is insufficient or the appearance of the card 10 raises suspicion that it has been altered or is counterfeit, the operator 44 directs the patron 11 to retrieve their card 10 and leave the establishment. The process then repeats with the next potential patron 60 in the entry line outside the outer doorway 46.

The images captured by the document camera 4, the portrait camera 5, the profile camera 6, and the entry line camera 20 are displayed on the monitor 9 and recorded on the VCR 8. An additional video monitor 62 (FIG. 1) may be connected to the quad split unit 7 and positioned at a remote location, such as the owner's office or a security office (not shown). If it is later determined that an underage patron has entered the premises 12, a review of the video cassette will prove whether or not the patron possibly used a false identification card.

While the operator may elect to use the system 1 only if the patron 11 appears underage, there are advantages in requiring each patron entering to submit to the identification transaction of the present invention. By this means, it can be demonstrated that it is the established practice of the establishment to require proof of age. A knowledge of this by potential patrons can function to discourage use of falsified identification cards and attempted entry by underage persons. Additionally, by requiring universal proof of age, allegations of illegal discrimination by the establishment based on factors other than age can be avoided.

While the system 1 has been described and illustrated as making use of conventional analog video components and recording equipment, it is foreseen that digitally based equipment and recording devices could also be employed. However, one of the advantages of video tape recording is that tampering with the images thereon, without noticeably diminishing the quality of the reproduced images, is very difficult.

It is also to be understood that the installation shown in FIG. 4 is for illustrative purposes and a wide range of configurations of the system 1 could be utilized depending on many factors including the layout of the premises on which the system 1 is to be utilized.

It is to be understood that while certain forms of the present invention have been illustrated and described herein, it is not to be limited to the specific forms or arrangement of parts described and shown.

What is claimed and desired to be secured by letters patent is as follows:

1. A system for recording an identification transaction of an individual and comprising:
(a) an identification document holder to receive an identification document associated with an individual;
(b) a document video camera positioned and focused to scan an image of said identification document positioned in said holder;
(c) a facial video camera positioned and focused to scan an image of the face of said individual simultaneous with the scanning of said identification document;
(d) an environment video camera positioned and focused to scan a moving image of placement of said identification document in said holder by said individual;
(e) video image combining circuitry having said document camera, said facial camera, and said environment camera coupled thereto and combining substantially simultaneous images from the respective cameras into a composite identification transaction image; and
(f) a video image recording device coupled to said image combining circuitry and recording said composite identification transaction image.

2. A system as set forth in claim 1 and including:
(a) a video monitor coupled to said video image combining circuitry and contemporaneously displaying said composite identification transaction image.

3. A system as set forth in claim 1 wherein:
(a) said video image recording device is a conventional video cassette recorder (VCR).

4. A system as set forth in claim 1 wherein:
(a) said system is installed to record an identification transaction associated with control of entry of individuals into a premises having an initial entry way;
(b) said system includes an entry line video camera positioned and focused to scan a moving image of individuals waiting at said entry way; and
(c) said entry camera is coupled to said video image combining circuitry which combines an entry line image into said composite identification transaction image.

5. A system as set forth in claim 4 wherein:
(a) said video image combining circuitry includes quad split circuitry which positions four input images into respective quadrants of a composite image.

6. A system as set forth in claim 1 wherein:
(a) said video image combining circuitry is capable of being controlled to assume a split image mode in which a plurality of input images are combined to a composite image and an isolation mode in which a single one of said input images is output in a full screen size; and
(b) said system includes a video mode selection switch coupled to said video image combining circuitry and operable to cause selection of said split image mode or said isolation mode, said isolation mode isolating a full screen image from said document camera to thereby provide greater readability of an identification document scanned by said document camera.

7. A system as set forth in claim 1 and including:
(a) a remote video monitor coupled to said video image combining circuitry and positioned at a location substantially remote from said identification document holder.

8. A method for recording an identification transaction of an individual and comprising the steps of:
(a) positioning an identification document in an identification document holder by an individual with whom said document is associated;
(b) scanning a document image of said identification document positioned in said holder using a document video camera;
(c) scanning a facial image of the face of said individual simultaneous with the scanning of said document image using a facial video camera;
(d) scanning a moving environment image of placement of said identification document in said holder by said individual using an environment video camera;
(e) combining said document image, said facial image, and said environment image which are contemporaneously scanned into a composite identification transaction image using video image combining circuitry coupled to said document camera, said facial camera, and said environment camera; and
(f) recording said composite identification transaction image using a video image recording device coupled to said image combining circuitry.

9. A method as set forth in claim 8 and including the step of:
(a) displaying said composite identification transaction image on a video monitor coupled to said video image combining circuitry.

10. A method as set forth in claim 8 and including the step of:
(a) recording said composite identification transaction image using a conventional video cassette recorder.

11. A method as set forth in claim 8 wherein said identification transaction is associated with control of entry of individuals into a premesis having an initial entry way, and including the steps of:
(a) scanning an entry line image of individuals waiting at said entry way using an entry line video camera coupled to said video image combining circuitry; and
(b) combining said entry line image into said composite identification transaction image using said video image combining circuitry.

12. A method as set forth in claim 11 and including the step of:
(a) combining said document image, said facial image, said environment image, and said entry line image into said composite identification transaction image using said video image combining circuitry which includes quad split circuitry which positions said images into respective quadrants of said composite identification transaction image.

13. A method as set forth in claim 8 and including the step of:
(a) controlling said video image combining circuitry to selectively record only said document image in a full screen sized format to thereby provide greater readability of an identification document scanned by said document camera.

14. A method as set forth in claim 8 and including the steps of:
(a) positioning a remote video monitor at a location substantially remote from said identification document holder;
(b) coupling said remote video monitor to said video image combining circuitry; and
(c) displaying said composite identification transaction image on said remote video monitor.
